(19) United States
(12) Patent Application Publication
(10) Pub. No.: US 2017/0214273 A1
(43) Pub. Date: Jul. 27, 2017

(54) DISTRIBUTED POWER SUPPLY SYSTEM, STATION CONTROL DEVICE, CONTROL METHOD, AND STORAGE MEDIUM IN WHICH PROGRAM IS STORED

(71) Applicant: NEC Corporation, Tokyo (JP)

(72) Inventors: Takuma KOGO, Tokyo (JP); Shantanu CHAKRABORTY, Tokyo (JP); Shin NAKAMURA, Tokyo (JP)

(73) Assignee: NEC Corporation, Tokyo (JP)

(21) Appl. No.: 15/329,590

(22) PCT Filed: Aug. 3, 2015
(86) PCT No.: PCT/JP2015/003898

§ 371 Date: Jan. 27, 2017

(30) Foreign Application Priority Data
Aug. 4, 2014 (JP) 2014-158810

(51) Int. Cl. H02J 13/00; H02J 3/00

(52) U.S. Cl. CPC H02J 13/0006; H02J 3/005

(57) ABSTRACT

[Problem] To provide a distributed power supply system having a plurality of micro-grids and capable of operating at low energy cost, a station control device, a control method, and a storage medium in which a control program is stored. [Solution] A station control device controls: the starting up and stopping of a distributed power supply for supplying power to a load that consumes power; the distributed power supply and said load; and the opening and closing of a switch for connecting another power supply controlled by another station control device. The station control device controls the switch and the distributed power supply on the basis of: demand power information indicating power consumed by the load; fuel efficiency information indicating the output-fuel consumption characteristics of the distributed power supply; the demand power information of another load to which another distributed power supply supplies power; and the fuel efficiency information of the other distributed power supply.

### TECHNICAL FIELD

The present invention relates to a distributed power supply system, a station control device, a control method, and a storage medium storing a program.

### BACKGROUND ART

Generally, a customer who has a load to receive power supply signs a contract with an electric power provider who supplies electric power, and receives power supply to the own load from a large-scale power plant/substation facility of the electric power provider in conformity with the contract.

In an isolated island or in a developing country, power supply performance by a large-scale power plant/substation facility of an electric power provider may not be sufficient. Therefore, there is performed a planned power cut in which an electric power provider temporarily interrupts power supply to a part of customers at a fixed time interval to keep balance between supply and demand of electric power.

In a district where a planned power cut frequently occurs, customers may own a generator using a fuel cell, a gas engine, a gas turbine, a micro gas turbine, a diesel engine, or the like, a cogeneration system using these generators, and the like, as power supplies disposed in a distributed manner near the district (hereinafter, distributed power supplies). During a power cut, electric power is supplied from distributed power supplies to loads to keep balance between supply and demand.

Meanwhile, a fuel consumption rate (L/h) when a rotation system generator such as a diesel generator is operated at a specific output (VA), in other words, an output-fuel consumption characteristic changes depending on generated electric power with respect to a rated value of a generator, that is, a load factor. Therefore, the higher the load factor is to operate a generator, the higher the output-fuel consumption characteristic becomes. Accordingly, it is possible to operate the generator at a lower energy cost. Thus, operating a distributed power supply at a minimum energy cost is considered.

A system described in PTL 1 includes constituting a customer group obtained by grouping a plurality of customers including a customer having a distributed power supply, and calculating a power generation output command value of a distributed power supply which is beneficial to the customer group. In order to implement the above, an energy management system is provided separately from a computer which controls a facility or an institution of a customer group, and the energy management system calculates a power generation output command value of a distributed power supply. The energy management system and the computer of the customer group are connected via a communication network, and the energy management system transmits a power generation command value to the computer.

Due to the aforementioned configuration, when a failure of a central control device or a failure of a communication network between the central control device and a station control device occurs, the station control device cannot receive a calculation result from the central control device.

In order to cope with the aforementioned failure, a system described in PTL 2 includes an alternative power supply command device based on unification of power supply stations belonging to other parties and supply-and-demand balance of the entire electric power system, and which is switchable as an alternative when an anomaly occurs in a power supply command device which issues a command for electric power generation to a power plant, and the power supply command device loses the function.

However, when a system includes an alternative power supply command device, an amount of equipment constituting the system such as a central control device and a communication network increases, as the system is multiplexed. Thus, there is a problem that the cost becomes high.

In view of the above, in a system described in PTL 3, a station control device which controls each customer group calculates an operation plan approximately optimal to a customer group to be controlled and each control device controls each customer group, when a central control device is malfunctioned or communication is disrupted.

### CITATION LIST

### Patent Literature

[PTL 1] Japanese Laid-open Patent Publication No. 2005-198423
[PTL 2] Japanese Laid-open Patent Publication No. 2006-129563
[PTL 3] Japanese Patent No. 3,980,541

### SUMMARY OF INVENTION

### Technical Problem

In the system described in PTL 3, calculation of an operation plan approximately optimal to an operation (hereinafter, an autonomous operation) in which each distributed control device controlling a customer group independently adjusts power supply and demand of each customer group. However, calculation of an operation plan to be performed by the system described in PTL 3 does not consider an operation (hereinafter, an interconnection operation) in which a distributed control device adjusts power supply and demand of other customer groups which are not controlled by the distributed control device, and transmits and receives electric power to and from the other customer groups. Therefore, an energy cost may increase in an operation plan to be determined by each distributed control device, as compared with an operation plan calculated by a central control device, which is performed in the system described in PTL 1 and the system described in PTL 2.

In view of the above, an object of the present invention is to provide a distributed power supply system, a station control device, a control method, and a storage medium storing a program, which solve at least one of the aforementioned problems.

### Solution to Problem

A station control device, according to the present invention, : controls start and stop of a distributed power supply which supplies electric power to a load consuming electric power, and connection and disconnection of a switch which connects the distributed power supply and the load with another distributed power supply controlled by another station control device; and to controls the switch and the distributed power supply, based on demand power information indicating electric power consumed by the load, fuel efficiency information indicating an output-fuel consumption characteristic of the distributed power supply, the demand power information of another load to which electric power is supplied by the another distributed power supply, and the fuel efficiency information of the another distributed power supply.

A station control device, according to the present invention,

controls start and stop of a distributed power supply which supplies electric power to a load consuming electric power, and connection and disconnection of a switch which connects a distributed power supply and the load with another distributed power supply controlled by another station control device; and

instructs another station control device to control the another distributed power supply, based on

demand power information indicating electric power consumed by the load, fuel efficiency information indicating an output-fuel consumption characteristic of the distributed power supply, the demand power information of another load to which electric power is supplied by the another distributed power supply, and the fuel efficiency information of the another distributed power supply.

A distributed power supply system, according to the present invention, comprises:

a plurality of micro-grids, each of which includes a load to which electric power is supplied, a distributed power supply which supplies electric power to the load, a switch which connects the load and the distributed power supply with another distributed power supply controlled by another station control device, and a station control device which controls the distributed power supply and the switch, wherein

at least one of the station control devices is a parent station control device which instructs control to the another station control device,

the another station control device includes transmitting/receiving means communicable with the parent station control device,

the transmitting/receiving means transmits, to the parent station control device, demand power information indicating electric power consumed by the load and fuel efficiency information indicating an output-fuel consumption characteristic of the another distributed power supply, and

the parent station control device includes
transmitting/receiving means which transmits and receives information to and from the another station control device, and
control determination means which determines an operation plan indicating combination of controlling contents of a distributed power supply and a switch of each of the plurality of micro-grids, wherein
the control determination means determines the operation plan, based on the demand power information of the load, the fuel efficiency information of the distributed power supply, and the fuel efficiency information and the demand power information of the another micro-grid acquired from the another station control device, and

the transmitting/receiving means transmits the operation plan to the another station control device.

A distributed power supply system, according to the present invention, comprises:

a distributed power supply which generates electric power, and another distributed power supply which generates electric power;

a plurality of loads to which electric power is supplied from the distributed power supply or another distributed power supply;

a station control device which controls start or stop of the distributed power supply;

another station control device which instructs another distributed power supply to start or stop; and

a plurality of switches which open or close connection of the distributed power supply and the another distributed power supply with the plurality of loads, wherein

the station control device instructs the distributed power supply and the another distributed power supply to start or stop, and instructs each of the plurality of switches to open or close, based on

demand power information indicating electric power consumed by the plurality of loads, and fuel efficiency information indicating an output-fuel consumption characteristic of the distributed power supply and the another distributed power supply.

A storage medium storing a control program, according to the present invention, which causes a computer to execute:

controlling start and stop of a distributed power supply which supplies electric power to a load consuming electric power, and connection and disconnection of a switch which connects a distributed power supply and the load with another distributed power supply controlled by another station control device; and

control process for controlling the switch and the distributed power supply by using
demand power information indicating electric power consumed by the load,
fuel efficiency information indicating an output-fuel consumption characteristic of the distributed power supply,
demand power information of another load to which electric power is supplied from the another distributed power supply, and
fuel efficiency information of the another distributed power supply.

A control method, according to the present invention, for controlling start and stop of a distributed power supply which supplies electric power to a load consuming electric power, and connection and disconnection of a switch which connects a distributed power supply and the load with another distributed power supply controlled by another station control device, the method comprises
controlling the switch and the distributed power supply by using
demand power information indicating electric power consumed by the load,
fuel efficiency information indicating an output-fuel consumption characteristic of the distributed power supply,
demand power information of another load to which electric power is supplied from the another distributed power supply, and
fuel efficiency information of the another distributed power supply.

### ADVANTAGEOUS EFFECTS OF INVENTION

It is possible to operate a distributed power supply system including a plurality of micro-grids at a low energy cost.

### BRIEF DESCRIPTION OF DRAWINGS

FIG. 1 is a diagram illustrating an example of a distributed power supply system in the present example embodiment.

FIG. 2 is a diagram illustrating an example of the distributed power supply system in the present example embodiment.

FIG. 3 is a diagram illustrating an example of a functional block of a station control device in the present example embodiment.

FIG. 4 is a diagram illustrating an example of a functional block of a station control device in the present example embodiment.

FIG. 5 is a flowchart illustrating an example of an operation of a station control device in the present example embodiment.

FIG. 6 is a diagram illustrating an example of a functional block of a station control device in the present example embodiment.

FIG. 7 is a diagram illustrating an example of a functional block of a station control device in the present example embodiment.

FIG. 8A is a diagram illustrating an example of equipment state information in the present example embodiment.

FIG. 8B is a diagram illustrating an example of equipment state information in the present example embodiment.

FIG. 9 is a flowchart illustrating an example of an operation of a station control device in the present example embodiment.

FIG. 10 is a diagram illustrating an example of a functional block of a station control device in the present example embodiment.

FIG. 11 is a flowchart illustrating an example of an operation of a station control device in the present example embodiment.

FIG. 12 is a flowchart illustrating an example of an operation of a station control device in the present example embodiment.

FIG. 13 is a diagram illustrating an example of a distributed power supply system in the present example embodiment.

### DESCRIPTION OF EMBODIMENTS

In the following, a distributed power supply system of example embodiments of the present invention will be described in detail according to the drawings.

### First Example Embodiment

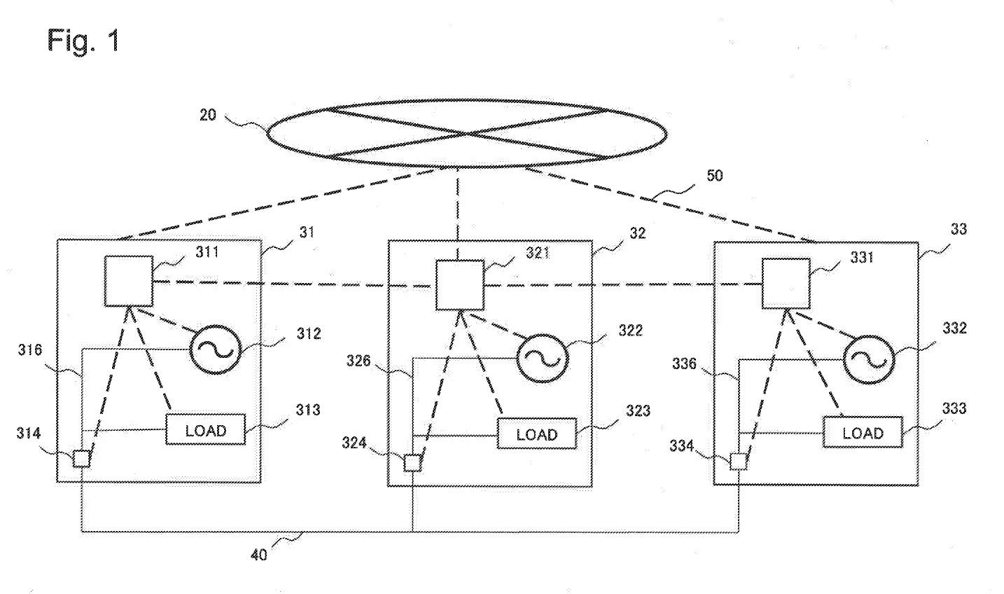

FIG. 1 is a diagram illustrating a distributed power supply system of an example embodiment of the present invention. The distributed power supply system in the present example embodiment includes a plurality of micro-grids 31, 32, and 33, a power line 40, a communication network 20, and a communication line 50. The plurality of micro-grids 31 to 33 are connected to each other via the power line 40. Further, the plurality of micro-grids 31 to 33 are connected to each other via the communication line 50 and the communication network 20.

A micro-grid is a unit including a station control device, a distributed power supply which supplies electric power, a load to which electric power generated by the distributed power supply is supplied, and a switch which electrically connects the distributed power supply and the load to a distributed power supply controlled by another station control device.

For instance, a micro-grid is formed by a distributed power supply 312 whose start and stop are controlled by a station control device 311, a switch whose opening and closing are controlled by the station control device 311, and a load 323 to which electric power is supplied from the distributed power supply 312. The sum of rated power to be consumed by loads included in a single micro-grid is equal to or less than the sum of rated power generation of distributed power supplies included in the micro-grid. An example of a single micro-grid is a single building such as an independently built house, a housing complex, or a shop, for instance. Further, a micro-grid includes a park, and a facility such as a commercial facility or an office in addition to a building; and includes a municipality or the like as a large unit. Note that each unit with which an electric power provider signs a contract, such as each house of a housing complex, a common area of a housing complex, each shop in a commercial facility, or a floor of a building may be a single load. A micro-grid may include a plurality of distributed power supplies and a plurality of loads.

Owners or managers of the plurality of micro-grids 31, 32, and 33 may be identical persons or persons having a common interest. When managers or owners of a plurality of micro-grids are identical or have a common interest, it becomes easy to distribute electric power and share information between the micro-grids.

The micro-grids 31, 32, and 33 each include station control devices 311, 321, and 331; distributed power supplies 312, 322, and 332; loads 313, 323, and 333; and switches 314, 324, and 334. A distributed power supply and a load within a micro-grid are connected via a power line 316, 326, or 336. The power line 40 is connected to the other micro-grids 32 and 33 and thus it is possible to transmit and receive electric power between the micro-grids.

A station control device controls start and stop of a distributed power supply, and opening and closing of a switch. The station control devices 311 to 331 communicate with the other micro-grids via the communication line 50 or the communication network 20. Further, the station control devices 311 to 331 monitor power supply and demand of each of the micro-grids 31 to 33.

A station control device in the present example embodiment calculates an operation plan indicating combination of start or stop of a distributed power supply, and closing or opening of a switch. The operation plan indicates combination as to which one of a plurality of distributed power supplies is started (or stopped), and which one of a plurality of switches is turned to ON-state (or OFF-state). The distributed power supply system in the present example embodiment includes: a station control device (hereinafter, a parent station control device) which designates control to the other station control devices and controls distributed power supplies and switches; and a station control device (hereinafter, a child station control device) which controls a distributed power supply and a switch according to an operation plan acquired from the parent station control device. The distributed power supply system may include at least one station control device as a candidate parent station control device. Alternatively, a plurality of station control devices may have a function as a parent station control device.

The distributed power supplies 312, 322, and 332 are devices which generate electric power with use of kinetic energy or chemical energy, and supply electric power to the loads 313, 323, and 333. The distributed power supply 312 is, for instance, a rotation system generator such as a diesel generator or a gas engine generator, or a fuel cell.

The loads 313, 323, and 333 are equipment, a facility, an institution, or the like to which electric power is supplied from the distributed power supplies 312, 322, and 332. The load 313 consumes or stores supplied electric power. The loads 313 to 333 are an electrical equipment such as an air conditioner, a lighting equipment, or a computer. Further, a storage battery may be a load. A single electrical equipment may be a single load. Alternatively, unit for a building or an area such as an independently built house, a shop, a housing complex, or an office having a plurality of electrical equipment may be a single load. Note that in the example illustrated in FIG. 1, a single micro-grid includes a single load. However, the number of loads included in a micro-grid may be one or more.

The switches 314, 324, and 334 are each connection circuits connecting or disconnecting between the micro-grids 31, 32, and 33, and the other micro-grids. In other words, the switches 314, 324, and 334 each connect and disconnect the distributed power supplies 312, 322, and 332, and the loads 313, 323, and 333, to the other micro-grids. When the switches 314 to 334 are in an ON-state, a micro-grid is electrically connected to the other micro-grids, and an interconnection operation is performed. When the switches 314 to 334 are in an OFF-state, a micro-grid is not connected to the other micro-grids, and an autonomous operation is performed. Note that the switches 314 to 334 may be constituted by breakers, or may be constituted by a device other than a breaker, as far as the function and the performance for cutting off the current are satisfied.

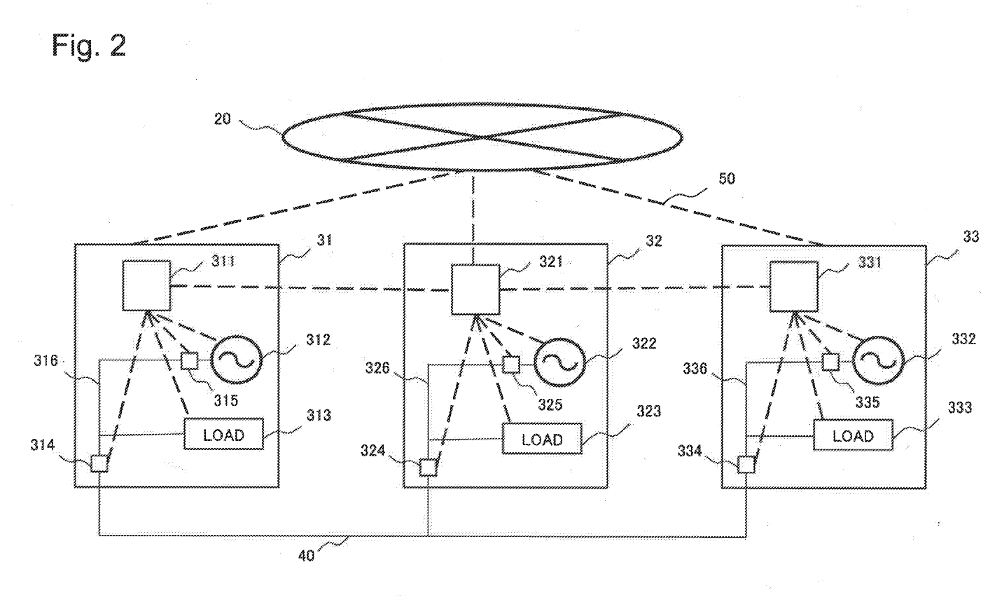

FIG. 2 illustrates a modification example of the distributed power supply system in the present example embodiment. Micro-grids 31 to 33 of the distributed power supply system in the example illustrated in FIG. 2 include second switches 315, 325, and 335. The second switch 315 connects or disconnects a distributed power supply 312 and a power line 316. When the second switch 315 is in an ON-state, the distributed power supply 312 is allowed to supply electric power to the power line 316. When the second switch 315 is in an OFF-state, the distributed power supply 312 does not supply electric power to the power line 316. In other words, the distributed power supply 312 stops the operation. The power supply 312 is safely disconnected from the power line 316 because of having a second switch. Note that the second switches 325 and 335 are also allowed to be safely disconnected from distributed power supplies 322 and 332, and power lines 326 and 336, respectively, in the same manner as the second switch 315.

A communication protocol between the station control devices 311 to 331; and a communication protocol between the station control devices 311 to 331, and the distributed power supplies 312 to 332, the switches 314 to 334, and the switches 315 to 335 to be controlled by the station control devices 311 to 331 are not limited.

Communication between the communication network 20 and the station control devices 311 to 331; and communication between the station control devices 311 to 331, and the distributed power supplies 312 to 332, the switches 314 to 334, and the switches 315 to 335 to be controlled by the station control devices 311 to 331 are desirably wired communication, but are not limited thereto. Wired communication and wireless communication may be mixed by partially using wireless communication. Further, when wired communication is not usable, communication may be continued by switching to wireless communication.

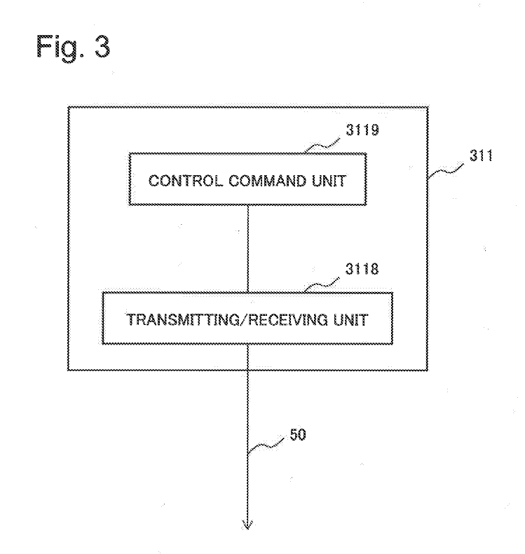

FIG. 3 illustrates an example of a functional block diagram of a child station control device in the present example embodiment. In this example, the distributed power supply system in the present example embodiment is described based on the premise that the station control device 321 is a parent station device, and the station control devices 311 and 331 are child station control devices. The station control device 311 in the present example embodiment includes a transmitting/receiving unit 3118 and a control command unit 3119.

The transmitting/receiving unit 3118 communicates with the distributed power supply 312, the load 313, the switch 314, and the other micro-grids, and transmits and receives information.

The transmitting/receiving unit 3118 communicates with the distributed power supply 312, the load 313, and the switch 314 via the communication line 50, and acquires fuel efficiency information. Further, the transmitting/receiving unit 3118 transmits fuel efficiency information to the station control device 321 which is a parent station control device, and acquires an operation plan indicating controlling contents with respect to the distributed power supply 312 and the switch 314 from the station control device 321. Control of the distributed power supply 312 represented by an operation plan may be start or stop of the distributed power supply 312, or may be change in the number of rotations of the distributed power supply 312. As control of the switch 314, an operation plan indicates closing or opening of the switch 314.

Fuel efficiency information is information indicating output-fuel consumption characteristics in power generation of a distributed power supply. Fuel efficiency information includes at least output-fuel consumption characteristics indicating a fuel consumption rate (L/h) when the distributed power supplies 312, 322, and 332 are operated at a specific output (VA), and a rated power generation amount of the distributed power supplies 312, 322, and 332. Further, as fuel efficiency information, a time constant of the distributed power supplies 312, 322, and 332, a resistance value of the power line 40, and the length of the power line 40 between the micro-grids may be acquired. As another example, fuel information (natural gas, gasoline, or the like) of each of the distributed power supplies 312, 322, and 332, and a fuel unit price may be acquired as fuel efficiency information.

The control command unit 3119 controls the distributed power supply 312 and the switch 314. The control command unit 3119 controls the distributed power supply 312 and the switch 314 according to an operation plan acquired from the transmitting/receiving unit 3118.

For instance, it is assumed that the control command unit 3119 acquires an operation plan indicating that the distributed power supply 312 is started, and the switch 314 is opened. In this case, the micro-grid 31 is not connected to the other micro-grids. In other words, the micro-grid 31 performs an operation (an autonomous operation) in which power supply and demand is adjusted independently of the other micro-grids.

On the other hand, it is assumed that the control command unit 3119 acquires an operation plan indicating that the distributed power supply 312 is started and the switch 314 is closed. In this case, the micro-grid 31 performs an operation (hereinafter, referred to as an interconnection operation) in which electric power is transmitted and received to and from the other micro-grid having the other switch to which closing is instructed. In other words, the micro-grid 31 and the other micro-grid which perform an interconnection operation form a single micro-grid.

Note that in the aforementioned example, the station control device 311 is described. However, the station control device 331 may have the same configuration and the same function as described above.

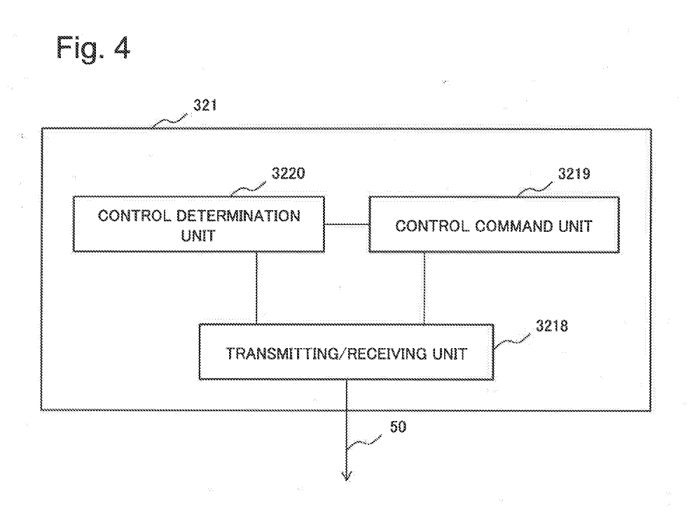

FIG. 4 illustrates an example of a functional block diagram of a parent station control device in the present example embodiment. In the present example embodiment, there is described an example in which the station control device 321 is a parent station control device. The station control device 321 in the present example embodiment includes a transmitting/receiving unit 3218, a control command unit 3219, and a control determination unit 3220. Note that in the following, a function relating to calculation of an operation plan is described, and description on a function common to the station control devices 31 and 33 is omitted as necessary.

The transmitting/receiving unit 3218 communicates with the distributed power supply 322, the load 323, the switch 324, and the other micro-grids, and transmits and receives information. The transmitting/receiving unit 3218 acquires fuel efficiency information of the distributed power supply 322, and fuel efficiency information of the distributed power supplies 312 and 332 included in the other micro-grids 31 and 33. Further, the transmitting/receiving unit 3218 acquires demand power information indicating demand power of each of the loads 313, 323, and 333. The transmitting/receiving unit 3218 transmits the acquired fuel efficiency information and the demand power information to the control determination unit 3220.

The demand power information indicates electric power to be consumed by the loads 313, 323, and 333 included in the micro-grids 31, 32, and 33. Note that electric power to be consumed by the loads 313, 323, and 333 may be electric power to be consumed by a load, or may be electric power to be supplied to a load. Alternatively, electric power to be stored in a storage battery may be included in electric power to be consumed by a load.

As the demand power information, a measurement value of demand power may be used. A method for acquiring a measurement value of demand power is not specifically limited. For instance, a power system disposed in the power lines 316, 326, and 336 may measure electric power to be supplied to the loads 313, 323, and 333. Alternatively, an HEMS (Home Energy Management System), a sensor, or the like may measure electric power consumed by the loads 313, 323, and 333. Further alternatively, a measurement value of electric power may be acquired by accessing a server which holds the measurement value of electric power via the communication network 20.

By using a measurement value of electric power, it is possible to more accurately reflect power demand by a load to control. Further, it is possible to calculate an operation plan with use of information with higher real-time reliability, because the station control device 311 which controls the load 313 calculates the operation plan.

As another example, an estimated value of demand power of each of the micro-grids 31, 32, and 33, or each of the loads 313, 323, and 333 may be acquired as demand power information. By using an estimated value of demand power, it is possible to use demand power information for a long period of time, as compared with a measurement value.

A period of time of demand power represented by demand power information is not specifically limited. For instance, demand power information for a period of time in conformity with a time required for calculation of an operation plan may be acquired. Further, the period of time may be changed as necessary such as every thirty minutes, every hour, or every day depending on measurement accuracy or estimation accuracy.

A method for the transmitting/receiving unit 3218 to acquire demand power information is not specifically limited. For instance, the transmitting/receiving device 3218 may access a server which provides demand power estimation information via the communication network 20, and may acquire demand power information. Alternatively, the transmitting/receiving unit 3218 may acquire power measurement information indicating electric power consumed by the load 313, and may set the acquired power measurement information as demand power information.

The transmitting/receiving unit 3218 transmits the received information to the control determination unit 3220.

The control determination unit 3220 calculates an operation plan of the micro-grids 31 to 33. An operation plan is information indicating combination of controlling contents (operations) with respect to the distributed power supplies 312, 322, and 332, and the switches 314, 324, and 334.

Combination of controls includes at least combination of start or stop of each of the distributed power supplies 312, 322, and 332, and closing or opening of each of the switches 314, 324, and 334. Further, information indicating the number of rotations, a rotational speed, and an operation mode of each of the distributed power supplies 312 to 332 may be included.

The control determination unit 3220 calculates an operation plan with less energy cost on the basis of demand power information of the micro-grids 31 to 33 and fuel efficiency information of the distributed power supplies 312, 322, and 332. An operation plan may be information indicating combination of controls between the switches 314, 324, and 334, and the distributed power supplies 312, 322, and 332 in a plurality of time zones.

An energy cost is a cost necessary for generating target electric power. An energy cost may be an amount of fuel necessary for generating unit power, for instance. Alternatively, an energy cost may be a fuel cost necessary for generating unit power.

In the following, there is described an example of a flow in which the control determination unit 3220 calculates an operation plan. The control determination unit 3220 obtains combination of the micro-grids 31, 32, and 33 which perform an interconnection operation. Note that combination of micro-grids which perform an interconnection operation may include a case in which there is no micro-grid which performs an interconnection operation (each of the micro-grids performs an autonomous operation).

Next, the control determination unit 3220 calculates combination of demand power in each of the combinations on the basis of the acquired demand power information. For instance, in the case of combination indicating that the micro-grid 31 and the micro-grid 32 perform an interconnection operation, and the micro-grid 33 performs an autonomous operation, the sum of demand power of the micro-grids 31 and 32 which perform an interconnection operation and demand power of the micro-grid 33 which performs an autonomous operation are demand power in the combination.

Then, distributed power supplies to be operated and an energy cost in this case are calculated regarding each of the combinations. For instance, in the aforementioned example, the distributed power supplies 312 and 322 are operable in the micro-grids which perform an interconnection operation, and the distributed power supply 332 is operated in the micro-grid which performs an autonomous operation. The control determination unit 3220 calculates an energy cost for each of the combinations of start and stop of the distributed power supplies 312 and 322, which are calculated based on fuel efficiency information.

Then, the control determination unit 3220 determines, as an operation plan, combination of an interconnection operation in which an energy cost is reduced and distributed power supplies to be operated in this case.

Note that the flow of calculating an operation plan is not limited to the aforementioned example. The order of an operation for the control determination unit 3220 to determine combination of start and stop of a distributed power supply; and determining combination of micro-grids which perform an interconnection operation, in other words, combination of closing and opening of a switch may be opposite.

Note that the control determination unit 3220 may calculate an operation plan of all the micro-grids 31 to 33, or may calculate an operation plan of a part of the micro-grids. For instance, an operation plan of the other micro-grids may be calculated only when combination in which the own micro-grid performs an interconnection operation is adopted. When it is determined that the own micro-grid 32 performs an autonomous operation, the determination may be notified to a station control device of the other micro-grid. A station control device of the other micro-grid which acquires information indicating that the micro-grid 32 performs an autonomous operation may calculate an operation plan regarding a plurality of micro-grids except for the micro-grid 32.

An algorithm to be used in calculation of an operation plan is not specifically limited. For instance, it is possible to use optimization calculation such as a mathematical programming process, metaheuristics as represented by a genetic algorithm, or round-robin calculation. The control determination unit 3220 may select an algorithm or the number of calculations to be used depending on computing power, as necessary. For instance, a calculation algorithm, a calculation variable, or the number of repetitions of calculation may be selected, by taking into consideration accuracy of an operation plan to be calculated or a calculation time. The control determination unit 3220 transmits a calculated operation plan to the control command unit 3219 and to the transmitting/receiving unit 3218.

The control command unit 3219 controls the distributed power supply 322 and the switch 324 according to the acquired operation plan.

Note that in the aforementioned example, the function of the station control device 321 included in the micro-grid 32 is described. However, the other station control devices 311 and 323 may be configured to have the same function as described above. Further, it is not necessary that all the station control devices 311 to 331 have the aforementioned function. It is sufficient that at least one of the station control devices 311 to 331 has the aforementioned function.

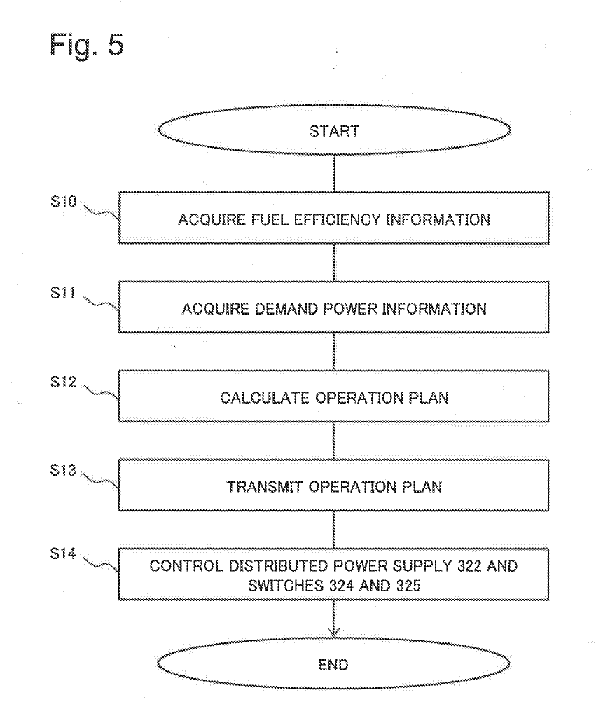

FIG. 5 is a flowchart illustrating an example of an operation of the station control device 321 in the present example embodiment.

In S10, the transmitting/receiving unit 3218 communicates with the distributed power supply 322, and acquires fuel efficiency information of the distributed power supply 322. Further, the transmitting/receiving unit 3218 communicates with the station control devices 311 and 331 included in the other micro-grids 31 and 33, and acquires fuel efficiency information of the distributed power supplies 312 and 332.

In S11, the transmitting/receiving unit 3218 acquires demand power information indicating electric power to be consumed by the loads 313, 323, and 333.

The control determination unit 3220 calculates (computes) an operation plan in such a manner that an energy cost is more reduced with use of the acquired fuel efficiency information of the distributed power supplies 312, 322, and 332, and the acquired demand power information of the loads 313, 323, and 333 (S 12). An operation plan is information indicating combination of controls of the distributed power supplies 312, 322, and 332, and the switches 314, 324, and 334. The control determination unit 3220 transmits a calculated operation plan to the control command unit 3219 and to the transmitting/receiving unit 3218.

The transmitting/receiving unit 3218 transmits an operation plan acquired from the control determination unit 3220 to the station control devices 311 and 331 of the corresponding micro-grids 31 and 33 (S13).

The control command unit 3219 controls the distributed power supply 322 and the switches 324 and 325 on the basis of the acquired operation plan (S 14).

In the foregoing, an example in which the station control device 321 of the micro-grid 32 calculates an operation plan is described. However, the station control devices 311 and 331 of the micro-grids 31 and 33 may have the same function as described above. Further, at least one of the plurality of the station control devices 311 to 331 may calculate an operation plan.

According to the present example embodiment, a station control device of a micro-grid is allowed to calculate an operation plan indicating combination of controls of the distributed power supplies 312 to 332 and the switches 314 to 334 with use of demand power information and fuel efficiency information of the other micro-grids, and is allowed to control each of the station control devices. According to the aforementioned example embodiment, a station control device which controls a load, a distributed power supply, and a switch of a micro-grid calculates an operation plan, thus reducing the cost is able to be intended without the need of an additional facility for calculating an operation plan.

Further, according to the present example embodiment, a station control device which manages and controls a facility or an institution such as a distributed power supply, a load, or a switch of a micro-grid calculates an operation plan, thus, real-time information can be used, as compared with a case in which a central control device is provided separately from a station control device which manages and controls a micro-grid.

### Second Example Embodiment

In the first example embodiment of the present invention, an operation plan is calculated in such a manner that the energy cost of the micro-grids 31, 32, and 33 is reduced with use of demand power estimation and fuel efficiency information. However, there is a case where an energy cost is reduced when continuing an operation of a distributed power supply in operation, as compared with stopping a distributed power supply in operation and starting the other distributed power supply. Further, an operation plan may possibly be calculated by including the distributed power supplies 312 and 332 and the switches 314 and 334, which are not usable due to maintenance, a failure, or the like.

In view of the above, a station control device in the present example embodiment calculates an operation plan with further use of equipment state information indicating an operation state of a distributed power supply 312 and a switch 314.

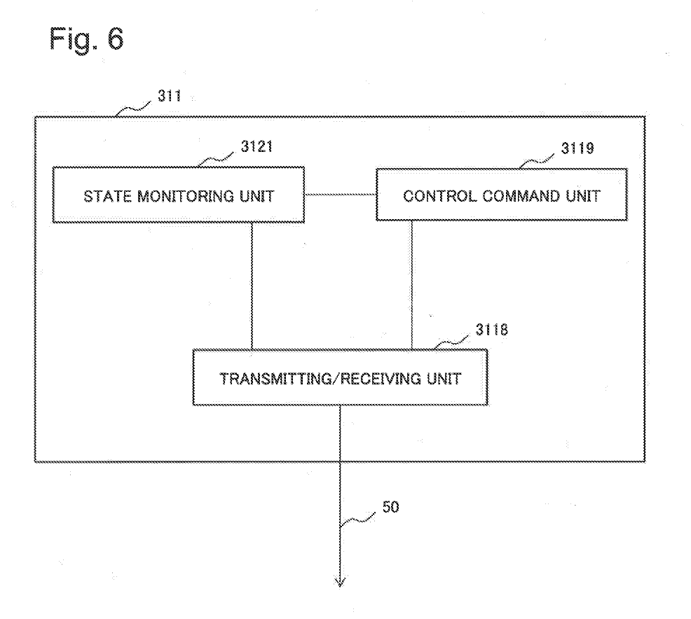

FIG. 6 illustrates an example of a functional block diagram of a child station control device in the present example embodiment. In a distributed power supply system in the present example embodiment, there is described a case in which a station control device 321 is a parent station control device, and station control devices 311 and 331 are child station control devices. The station control device 311 in the present example embodiment includes a transmitting/receiving unit 3118, a control command unit 3119, and a state monitoring unit 3121. In the following description, there is described a function of acquiring equipment state information of the distributed power supply 312 and the switch 314 by the station control device 311, and description on functions that overlap the functions of the first example embodiment is omitted as necessary.

The transmitting/receiving unit 3118 acquires fuel efficiency information from the distributed power supply 312, and receives an operation plan from the other station control device 321.

The transmitting/receiving unit 3118 communicates with the distributed power supply 312 and the switch 314, and acquires equipment state information indicating information indicating an operation state of the distributed power supply 312 and the switch 314. An operation state is information indicating that a distributed power supply is started or stopped, or a switch is closed or opened. Further, an operation state may be information indicating at which number of rotations and at which load factor, a distributed power supply is operated. Further, an operation history indicating how a distributed power supply is operated for a predetermined period of time in the past may be acquired, in addition to real-time information. In addition to the above, information indicating an opening/closing state of the second switch 315, or information indicating a degree of deterioration of the distributed power supply 312 and the switch 314, or information indicating whether or not there is a failure or maintenance may be acquired. The transmitting/receiving unit 3118 transmits the acquired information to the state monitoring unit 3121. The state monitoring unit 3121 monitors a state of the distributed power supply 312, a load 313, and the switch 314 of a micro-grid 31. The state monitoring unit 3121 is allowed to detect whether or not there is an anomaly in a distributed power supply, a load, and a switch on the basis of equipment state information acquired from the transmitting/receiving unit 3118, and is allowed to judge whether or not the distributed power supply 312 and the switch 314 are usable.

For instance, when the distributed power supply 312 and the switch 314 represented by equipment state information are operated in a state different from the combination of controls at a target point of time represented by an operation plan, the distributed power supply 312 and the switch 314 operated in the different state are regarded as in an anomalous state. The state monitoring unit 3121 judges that equipment which is detected to be anomalous is not usable.

Further, it is judged as to whether or not the distributed power supply 312 and the switch 314 are usable based on presence/absence of a failure or maintenance of the distributed power supply 312 and the switch 314 indicated by equipment state information.

The state monitoring unit 3121 may judge whether or not the distributed power supply 312 and the switch 314 are usable with use of information other than an operation plan and equipment state information. For instance, the state monitoring unit 3121 may acquire information such as the weather or the presence/absence of disconnection of the power line 40 as external information, and may judge that the distributed power supply 312 is not usable when there is a possibility that a failure may occur in the distributed power supply 312 or the load 313 due to thunder or the like. Alternatively, when disconnection of the power line 40 is acquired as external information, the state monitoring unit 3121 may judge that the switch 314 is closed (it is impossible to open the switch 314). Thus, the distributed power supply 312 and the load 313 are protected when an anomaly occurs.

The state monitoring unit 3121 may add a judgment result on usability to equipment state information, and may transmit the information to the transmitting/receiving unit 3118 and the control command unit 3119.

The control command unit 3119 controls the distributed power supply 312 and the switch 314. The control command unit 3119 acquires equipment state information from the state monitoring unit 3121, and controls the distributed power supply 312 and the switch 314. For instance, when acquiring equipment state information indicating that the distributed power supply 312 is not usable, the control command unit 3119 may stop the operation of the distributed power supply 312.

Note that in the aforementioned example, the station control device 311 is described. However, the configuration and the function of the station control device 331 may be the same as the station control device 311.

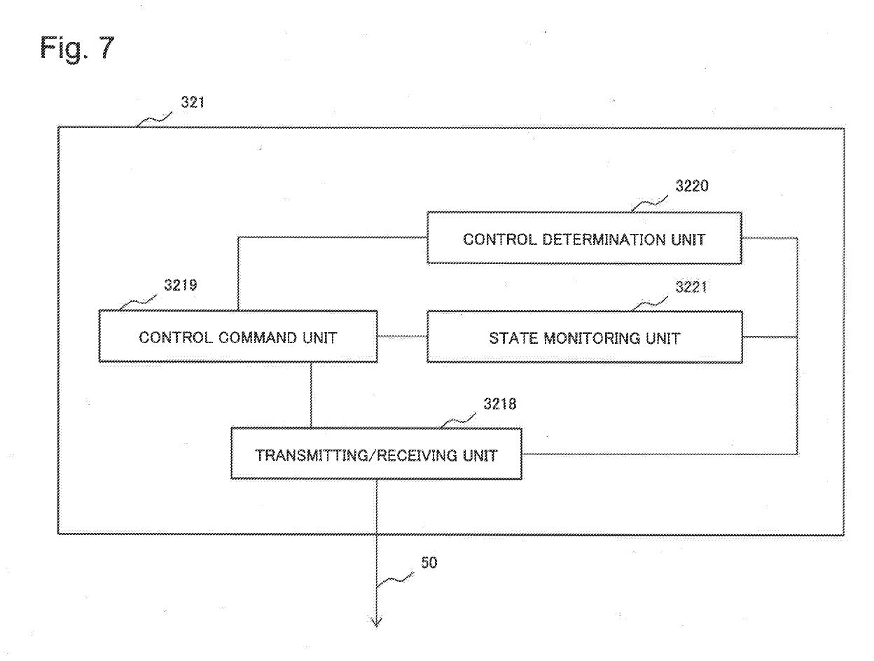

FIG. 7 illustrates an example of a functional block diagram of a parent station control device in the present example embodiment. In the present example embodiment, there is described an example in which the station control device 321 is a parent station control device. The station control device 321 in the present example embodiment includes the transmitting/receiving unit 3218, a control command unit 3219, a control determination unit 3220, and a state monitoring unit 3221. In the following, there is described a function of calculating an operation plan with further use of equipment state information indicating a state of a micro-grid, and description on functions which overlap the functions of the first example embodiment is omitted as necessary.

The transmitting/receiving unit 3218 communicates with a distributed power supply 322, a load 323, a switch 324, and the other micro-grids, and transmits and receives information. The transmitting/receiving unit 3218 acquires fuel efficiency information of the distributed power supplies 312, 322, and 332, demand power information of the loads 313, 323, and 333, and equipment state information of the micro-grids 31, 32, and 33. The transmitting/receiving unit 3218 transmits acquired fuel efficiency information and demand power information to the control determination unit 3220. Further, the transmitting/receiving unit 3219 transmits the acquired equipment state information of the micro-grid 32 to the state monitoring unit 3221.

The state monitoring unit 3221 monitors a state of the micro-grid 32. The state monitoring unit 3221 is allowed to detect whether or not there is an anomaly in the distributed power supply 322 and the switch 324 based on equipment state information acquired from the transmitting/receiving unit 3218, and is allowed to judge whether or not the distributed power supply 322 and the switch 324 are usable. The state monitoring unit 3221 may add a judgement result on usability to equipment state information, and may transmit the information to the control determination unit 3220.

The control determination unit 3220 calculates an operation plan of less energy cost on the basis of demand power information of the loads 313 to 333, fuel efficiency information of the distributed power supplies 312, 322, and 332, and equipment state information of the micro-grids 31 to 33. The control determination unit 3220 transmits the calculated operation plan to the control command unit 3219 and the transmitting/receiving unit 3218.

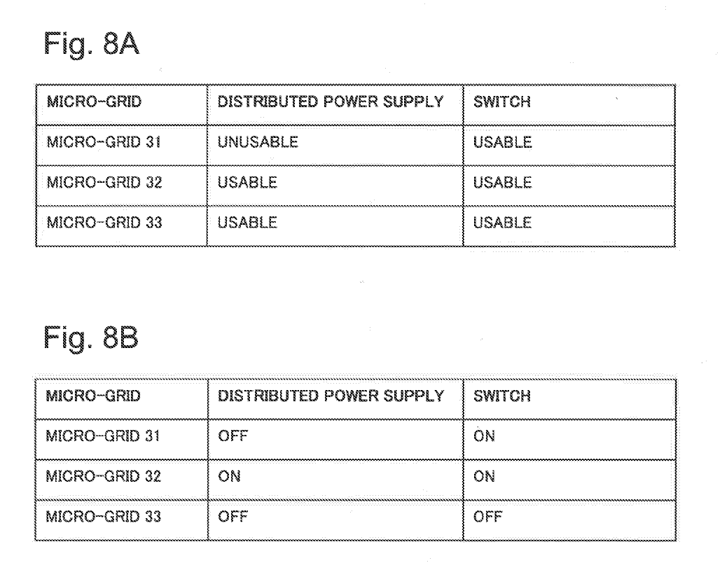

An example in which the control determination unit 3220 calculates an operation plan on the basis of demand power information, fuel efficiency information, and equipment state information is described referring to FIG. 8A and FIG. 8B.

FIG. 8A illustrates an example of equipment state information acquired by the control determination unit 3220. As illustrated in FIG. 8A, equipment state information in the example indicates that the distributed power supply 312 is not usable, and the distributed power supplies 322 and 332, and the switches 314, 324, and 334 are usable. In this case, electric power is not supplied from the distributed power supply 312 to the load 313 of the micro-grid 31. Therefore, the control determination unit 3220 closes the switch 314, and at least one of the switch 324 and the switch 334.

Next, the control determination unit 3220 calculates an operation plan in such a manner that the energy cost of the micro-grids 31, 32, and 33 is more reduced on the basis of demand power information and fuel efficiency information. The control determination unit 3230 calculates an operation plan in such a manner that at least one of distributed power supplies and at least one of switches both of which are indicated as usable by equipment state information are started and closed, respectively. FIG. 8B illustrates an example of a calculated operation plan. In this example, an operation plan indicating that the micro-grid 31 and the micro-grid 32 perform an interconnection operation, and the micro-grid 33 performs an autonomous operation is calculated.

In other words, when equipment state information indicates that a distributed power supply is not usable, an operation plan is calculated in such a manner that the micro-grid 31 including the distributed power supply 312 which is judged to be unusable, and at least one of the other micro-grids perform an interconnection operation.

As another example, it is assumed that the control determination unit 3220 acquires equipment state information indicating start or stop of the distributed power supplies 312, 322, and 332, and closing or opening of the switches 314, 324, and 334. In this case, the control determination unit 3220 may calculate an operation plan by prioritizing “starting” a distributed power supply, which is indicated as “started”. Alternatively, the control determination unit 3220 may compare an operation plan in the case where an “started” distributed power supply is “stopped” with use of fuel efficiency information, and an operation plan in the case where an operation of an “started” distributed power supply is “started” (the operation is continued); and may adopt the operation plan of less energy cost. According to this example, it is possible to calculate an operation plan in which the energy necessary for switching between start and stop of a distributed power supply is included in the energy cost. This is advantageous in further reducing the energy cost.

The control command unit 3219 controls the distributed power supply 322 and the switch 324 according to an acquired operation plan.

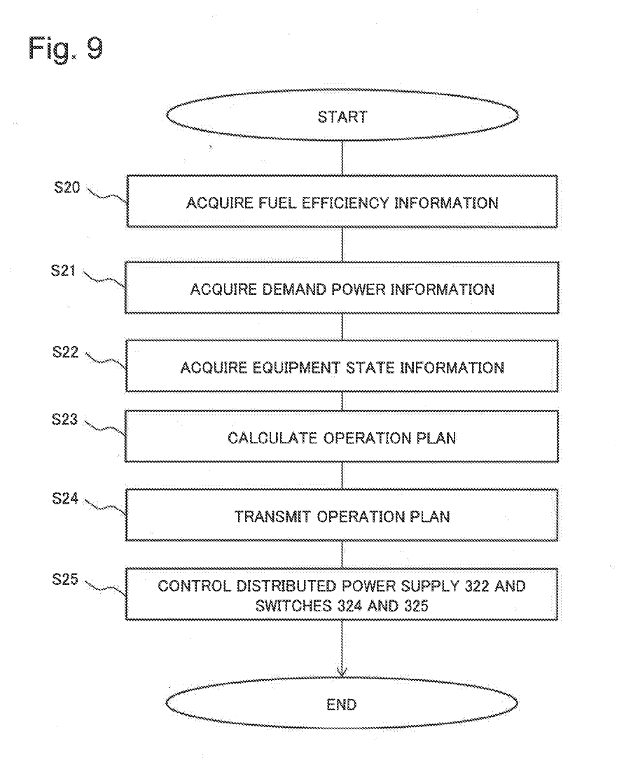

FIG. 9 illustrates an example of a flowchart of calculating an operation plan in the station control device 321 of the present example embodiment.

The transmitting/receiving unit 3218 communicates with the distributed power supply 322, and acquires fuel efficiency information of the distributed power supply 322. Further, the transmitting/receiving unit 3218 communicates with the station control devices 311 and 331 included in the other micro-grids 31 and 33, and acquires fuel efficiency information of the distributed power supplies 312 and 332 (S20).

In S21, the transmitting/receiving unit 3218 acquires demand power information indicating an estimated value of demand power of each of the loads 313, 323, and 333 in a predetermined period of time.

In S22, the transmitting/receiving unit 3218 acquires equipment state information indicating an operation state of the distributed power supplies 312, 322, and 332, and the switches 314, 324, and 334. The equipment state information is information indicating that a distributed power supply is started or stopped, and a switch is closed or opened. Further, the equipment state information may include information indicating whether or not a distributed power supply and a switch are usable. The transmitting/receiving unit 3118 transmits the acquired information to the state monitoring unit 3221.

In S23, the control determination unit 3220 calculates an operation plan of less energy cost on the basis of demand power information of the micro-grids 31 to 33, fuel efficiency information of the distributed power supplies 312, 322, and 332, and equipment state information of the micro-grids 31 to 33. The control determination unit 3220 transmits a calculated operation plan to the control command unit 3219 and the transmitting/receiving unit 3218.

When acquiring information indicating start or stop of the distributed power supplies 312, 322, and 332, and closing or opening of the switches 314, 324, and 334 as equipment state information, the control determination unit 3220 may calculate an operation plan in such a way as to continue an equipment state represented by the equipment state information. When further acquiring information indicating whether or not the distributed power supplies 312, 322, and 332, and the switches 314, 324, and 334 are usable as an equipment state, the control determination unit 3220 calculates an operation plan in such a way as to prioritize compensating demand and supply of a micro-grid including at least one of a distributed power supply and a switch which are judged to be unusable.

The control determination unit 3220 transmits a calculated operation plan to the control command unit 3219 and the transmitting/receiving unit 3218.

In S24, the transmitting/receiving unit 3218 transmits an operation plan acquired from the control determination unit 3220 to the station control devices 311 and 331 of the corresponding micro-grids 31 and 33.

In S25, the control command unit 3219 controls the distributed power supply 322 and the switches 324 and 325 on the basis of the acquired operation plan.

In the foregoing, there is described an example in which the station control device 321 of the micro-grid 32 calculates an operation plan. However, the station control devices 311 and 331 of the micro-grids 31 and 33 may have the same function as the function of the station control device 321 of the micro-grid 32. Further, it is sufficient when at least one of the station control devices 311 to 331 can calculate an operation plan.

According to the present example embodiment, an operation plan is calculated on the basis of demand power information, fuel efficiency information, and equipment state information, and the distributed power supplies 312, 322, and 332, and the switches 314, 324, and 334 are controlled. Further, the order of the processes of S20 to S22 may be changed as necessary.

According to the present example embodiment, it is possible to calculate an operation plan by taking into consideration an energy cost required for switching an operation state of a distributed power supply. This is advantageous in further reducing the energy cost.

Further, in the present example embodiment, it is possible to calculate an operation plan by taking into consideration whether or not a distributed power supply and a switch are usable. According to this example embodiment, it is possible to control each of the micro-grids by an operation plan in conformity with a state of a distributed power supply and a switch of a micro-grid. In other words, it is possible to reduce inconveniences that an autonomous operation is instructed to a micro-grid including a distributed power supply which is not usable due to maintenance, a failure, an anomaly, or the like, and electric power cannot be supplied to a load of the micro-grid.

### Third Example Embodiment

When the number of communicable station control devices is small, the scale of a micro-grid for which an operation plan is performed is reduced. In this case, an advantageous effect of energy cost reduction may not be sufficiently obtained even when an operation plan is calculated and control is performed. In view of the above, in the present example embodiment, an operation plan is calculated when a micro-grid for which the operation plan is performed satisfies a predetermined condition. In the present example embodiment, an operation plan is calculated with respect to a micro-grid to which at least a communicable station control device belongs.

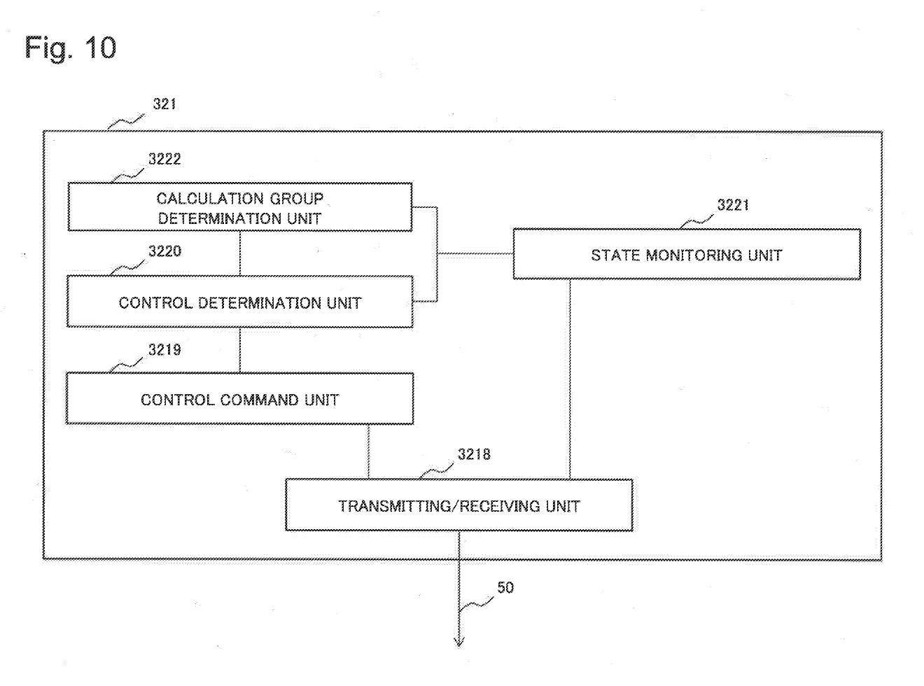

FIG. 10 illustrates an example of a functional block diagram of a parent station control device in the present example embodiment. In the present example embodiment, there is described an example in which a station control device 321 is a parent station control device. The station control device 321 in the present example embodiment includes a transmitting/receiving unit 3218, a control command unit 3219, a control determination unit 3220, a state monitoring unit 3221, and a calculation group determination unit 3222. In the following, functions different from those of the first and second example embodiments are described, and description on the same functions as those of the first and second example embodiments is omitted as necessary.

The transmitting/receiving unit 3218 communicates with a distributed power supply 322, a load 323, a switch 324, and the other micro-grids, and transmits and receives information. The transmitting/receiving unit 3218 acquires fuel efficiency information of the distributed power supplies 312, 322, and 332, demand power information of the loads 313, 323, and 333, and an identifier of each of the micro-grids. The transmitting/receiving unit 3218 transmits the acquired fuel efficiency information and demand power information to the control determination unit 3220. Further, the transmitting/receiving unit 3219 transmits the acquired identifiers to the state monitoring unit 3221. Note that although not illustrated in FIG. 10, the transmitting/receiving unit 3218 is connected one another with the control determination unit 3220 and the calculation group determination unit 3222, for instance.

The identifier is information indicating a micro-grid to which a station control device as a transmission source belongs. For instance, the station control device 311 belongs to the micro-grid 31. Therefore, an identifier identifying the micro-grid 31 is transmitted to the station control device 321. The identifier may further include information indicating an attribute of a micro-grid, such as the number, the rated power, or the type of loads included in a micro-grid (such as an electrical equipment, a lighting equipment, a housing, a factory, or an office), the area of the micro-grid, or the manager of the micro-grid.

The state monitoring unit 3221 judges whether or not being communicable with the other station control devices 311 and 331 on the basis of the acquired identifiers.

A method for the state monitoring unit 3221 to judge whether or not being communicable with the other station control devices 311 and 331 is not specifically limited. For instance, when the transmitting/receiving unit 3218 acquires identifiers indicating the other micro-grids 31 and 33, the state monitoring unit 3221 may judge being communicable with the station control devices 311 and 331 of the micro-grids 31 and 33. Alternatively, the state monitoring unit 3221 may judge being communicable with the other station control devices 311 and 331 when the transmitting/receiving unit 3218 has succeeded in transmitting and receiving an identifier to and from the other station control devices 311 and 331. In this case, the transmitting/receiving unit 3218 transmits the identifier of the micro-grid 32 to the station control devices 311 and 331. The state monitoring unit 3221 may judge being communicable with the station control devices 311 and 331 when receiving the identifier of the micro-grid 32 and the identifier of the other micro-grid as a transmission source from the station control devices 311 and 331 before a predetermined period of time is elapsed.

Note that a micro-grid which is directly communicable with the station control device 321 via the communication line 50 may be judged to be communicable. Alternatively, a device including a station control device which is communicable via the other station control device by a multi-hop method or the like may be judged to be communicable. When judgment is made via the other station control device, a station control device to be relayed may add the identifier of the own micro-grid to the identifier of a transmission source.

The state monitoring unit 3221 may judge whether or not there is a delay in communication with respect to the other station control devices 311 and 331. The state monitoring unit 3221 may judge whether or not there is a delay in communication by causing the transmitting/receiving unit 3218 to transmit information to the other station control devices 311 and 331, and by measuring a time required for the transmitting/receiving unit 3218 to receive information from the other control devices 311 and 331.

The state monitoring unit 3221 transmits the identifier of the other micro-grid which is judged to be communicable to the calculation group determination unit 3222. Note that when it is further judged whether or not there is a delay in communication, the identifier of a micro-grid in which there is no delay in communication may be transmitted to the calculation group determination unit 3222.

The calculation group determination unit 3222 determines a calculation group for which an operation plan is calculated. The calculation group is a group of micro-grids which are communicable with the station control device 321 which calculates an operation plan, and micro-grids for which an operation plan is calculated by the station control device 321 among a distributed system. The calculation group determination unit 3222 determines a calculation group by comparing an acquired identifier, and a predetermined condition. When the identifier of a communicable micro-grid satisfies a predetermined condition, the micro-grid which satisfies the condition is determined as a calculation group. When a communicable micro-grid does not satisfy the predetermined condition, the calculation group determination unit 3222 may determine that an operation plan is not calculated. The calculation group determination unit 3222 transmits a determined calculation group to the control determination unit 3220. When it is determined that an operation plan is not calculated, the calculation group determination unit 3222 transmits the determination result to the transmitting/receiving unit 3218.

A condition for determining a calculation group is not limited. For instance, when the sum of a target micro-grid, and micro-grids which are judged to be communicable by the state monitoring unit 3221 is equal to a certain value or more (such as 50% or more, or 70% or more), the calculation group determination unit 3222 may determine the micro-grids which are communicable with the target micro-grid 32 as a calculation group. Alternatively, the calculation group determination unit 3222 may determine a calculation group with use of identifiers and demand power information. For instance, when sum of estimated values of demand power represented by acquired demand power estimation information of the other micro-grids, and demand power information of the target micro-grid 32 is equal to or larger than a certain ratio of an estimated value of demand power in a distributed system, the calculation group determination unit 3222 may determine a group of the micro-grids as a calculation group. As another example, when an identifier includes information indicating an attribute of micro-grids, the calculation group determination unit 3222 may determine a group of the micro-grids as a calculation group, by taking into consideration the attribute of the micro-grids. Note that the number of calculation groups to be determined by the calculation group determination unit 3222 may be one or more. When the calculation group determination unit 3222 determines a plurality of calculation groups, the calculation group determination unit 3222 calculates an operation plan for each of the calculation groups.

The control determination unit 3220 calculates an operation plan in such a manner that the energy cost of a micro-grid belonging to a calculation group is more reduced. The control determination unit 3220 calculates an operation plan in which the energy cost of a micro-grid belonging to a calculation group is more reduced with use of demand power information and fuel efficiency information of the micro-grid belonging to the calculation group.

The control determination unit 3220 may calculate an operation plan in which an autonomous operation is instructed with respect to each of communicable micro-grids when acquiring information indicating that an operation plan is not calculated from the calculation group determination unit 3222.

The control command unit 3219 controls the distributed power supply 322 and the switch 324 according to the acquired operation plan.

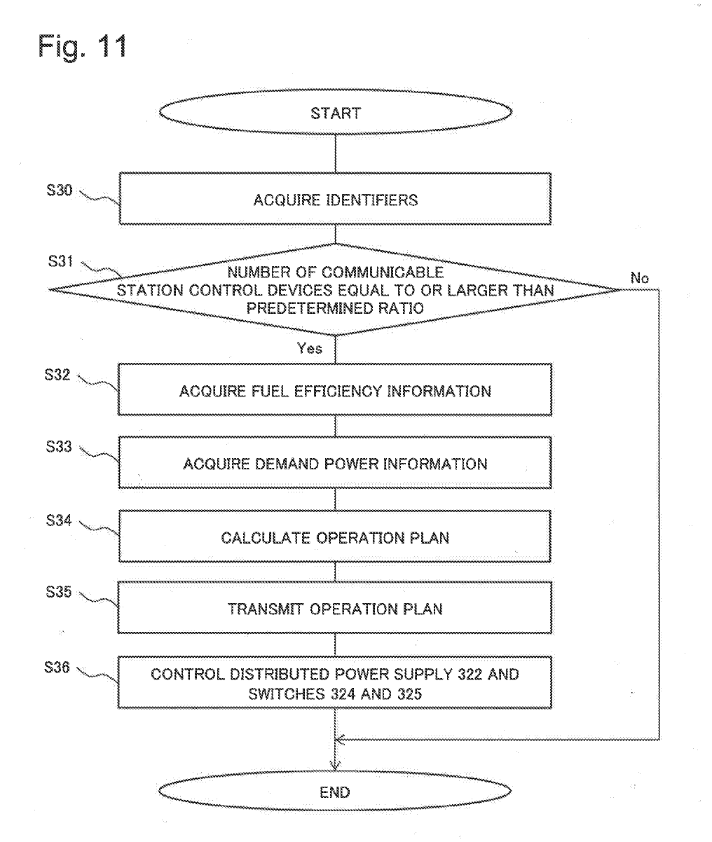

FIG. 11 is a flowchart illustrating an example of an operation of a station control device in the present example embodiment.

In S30, the transmitting/receiving unit 3218 acquires identifiers of the corresponding micro-grids 31 and 33 from the station control devices 311 and 331. The transmitting/receiving unit 3218 transmits the acquired identifiers to the state monitoring unit 3221.

In S31, the state monitoring unit 3221 judges a communicable station control device on the basis of the acquired identifiers. The state monitoring unit 3221 may judge a station control device corresponding to the other micro-grid represented by the acquired identifier as a communicable station control device. Alternatively, the state monitoring unit 3221 may judge that a station control device is communicable when the transmitting/receiving unit 3218 has succeeded in transmitting and receiving an identifier to and from and the other station control devices 311 and 331.

The state monitoring unit 3221 may further judge whether or not there is a delay in communication between the station control device 321 and another station control device 321. The state monitoring unit 3221 transmits the identifier of the other micro-grid which is judged to be communicable to the calculation group determination unit 3222. Note that when it is further judged as to whether or not there is a delay in communication, the state monitoring unit 3221 may transmit the identifier of a micro-grid with no delay in communication to the calculation group determination unit 3222.

In S31, the calculation group determination unit 3222 determines a calculation group by comparing the identifier of a communicable micro-grid, with a predetermined condition. When the identifier of a communicable micro-grid satisfies a predetermined condition, the calculation group determination unit 3222 determines the micro-grid that satisfies the condition as a calculation group, and transmits the determination result to the control determination unit 3220.

When a communicable micro-grid does not satisfy the predetermined condition, the calculation group determination unit 3222 determines that an operation plan is not calculated. The calculation group determination unit 3222 transmits the determined calculation group to the control determination unit 3220, and terminates calculation of an operation plan.

In the following, there is described a case in which the calculation group determination unit 3222 determines a calculation group, and an operation plan is calculated.

In S32, the receiving unit 3218 communicates with the distributed power supply 322, and acquires fuel efficiency information of the distributed power supply 322. Further, the transmitting/receiving unit 3218 communicates with a station control device included in a micro-grid which belongs to a calculation group, and acquires fuel efficiency information of a distributed power supply. The transmitting/receiving unit 3218 transmits the acquired fuel efficiency information to the control determination unit 3220.

In S33, the transmitting/receiving unit 3218 acquires demand power information indicating demand power of a load included in a micro-grid which belongs to a calculation group. The transmitting/receiving unit 3218 transmits the acquired demand power information to the control determination unit 3220.

In S34, the control determination unit 3220 calculates (computes) an operation plan in such a manner that an energy cost is more reduced on the basis of fuel efficiency information and demand power information acquired from the transmitting/receiving unit, and on the basis of identifiers acquired from the state monitoring unit 3221. The control determination unit 3220 selects fuel efficiency information and demand power information corresponding to a micro-grid which belongs to a calculation group, by referring to the acquired fuel efficiency information and identifiers. The control determination unit 3220 calculates an operation plan in such a manner that an energy cost of a micro-grid which belongs to a calculation group is minimized with use of the selected fuel efficiency information and demand power information.

The control determination unit 3220 transmits the calculated operation plan to the transmitting/receiving unit 3218 and the control command unit 3219.

In S35, the transmitting/receiving unit 3218 transmits an operation plan acquired from the control determination unit 3220 to a station control device of a micro-grid which belongs to a calculation group.

The control command unit 3219 controls the distributed power supply 322 and the switches 324 and 325 on the basis of the acquired operation plan.

According to the present example embodiment, an operation plan is performed when the other communicable station control device satisfies a predetermined condition. According to the present example embodiment, it is possible to effectively reduce the energy cost because an operation plan is performed when the scale of a micro-grid for which an operation plan is calculated is sufficiently large.

### Fourth Example Embodiment

When a station control device which undertakes an operation plan with respect to a plurality of micro-grids is unstable, inconveniences may occur that an operation plan is incomplete or a control command cannot be transmitted to the other station control device. In view of the above, in the present example embodiment, a station control device suitable for an operation plan is determined to be a parent station control device.

FIG. 7 illustrates an example of a functional block diagram of a parent station control device in the present example embodiment in the same manner as the second example embodiment. A station control device 321 in the present example embodiment includes a transmitting/receiving unit 3218, a control command unit 3219, a control determination unit 3220, and a state monitoring unit 3221. Note that in the following, functions different from those of the first to third example embodiment are described, and description on the same functions as those of the first and second example embodiment is omitted as necessary.

The transmitting/receiving unit 3218 communicates with a distributed power supply 322, a load 323, a switch 324, and the other micro-grids, and transmits and receives information. The transmitting/receiving unit 3218 acquires fuel efficiency information of the distributed power supplies 312, 322, and 332, demand power information of the loads 313, 323, and 333, and an identifier of each of the micro-grids. The transmitting/receiving unit 3218 transmits the acquired fuel efficiency information and demand power information to the control determination unit 3220. Further, the transmitting/receiving unit 3218 transmits the acquired identifiers to the state monitoring unit 3221.

An identifier in the present example embodiment includes information indicating a micro-grid to which a station control device as a transmission source belongs. Further, the identifier may further include information indicating a processing ability of a station control device as a transmission source.

The state monitoring unit 3221 determines a parent station control device which calculates an operation plan on the basis of the acquired identifiers. The state monitoring unit 3221 determines one parent station control device, and at least one child station control device on the basis of predetermined parent-child determination criteria and identifiers.

Parent-child determination criteria are not specifically limited. For instance, parent-child determination criteria may be criteria such that a station control device in a good communication environment is made to be a parent station control device. A station control device in which there is less delay in communication, or a station control device with a large number of directly communicable station control devices may be selected as a parent station control device from the acquired identifiers. By selecting a station control device in a good communication environment as a parent, it is possible to reduce the risk of failure in transmitting and receiving information to and from the other station control device.

When an acquired identifier includes information indicating a processing ability of a station control device, the processing ability of the station control device may be used as parent-child determination criteria.

The state monitoring unit 3221 may compare between processing abilities of station control devices represented by the acquired identifiers, and may set a station control device including the control determination unit 3220, or a station control device having a highest processing ability, as a parent station control device. Alternatively, the state monitoring unit 3221 may set a station control device having a processing ability of a certain level or higher as a parent station control device. The number of criteria to be used as parent-child determination criteria may be one or more. Note that the state monitoring unit 3221 may determine that an operation plan is not calculated when there is no station control device that satisfies parent-child determination criteria.

A method for the state monitoring unit 3221 to acquire parent-child determination criteria is not specifically limited. Parent-child determination criteria may be held in the state monitoring unit 3221, or may be acquired from an external server or the like via a communication network 20. It is preferable that station control devices 311, 321, and 331 use the same parent-child determination criteria. By using the same determination criteria, it is possible to select the same station control device as a parent when each of a plurality of station control devices determines a parent station control device, for instance. Thus, inconveniences, that a device is selected from a plurality of parent control devices, and a plurality of operation plans are transmitted, can be reduced.

The state monitoring unit 3221 transmits a parent-child judgment result to the control determination unit 3220 and the transmitting/receiving unit 3218. The transmitting/receiving unit 3218 which acquires a parent-child judgment result transmits the parent-child judgment result to the other station control devices 311 and 331.

When acquiring information indicating that the station control device 321 is a parent station control device, the control determination unit 3220 calculates an operation plan in which an energy cost is reduced on the basis of demand power information of the loads 313 to 333, fuel efficiency information of the distributed power supplies 312, 322, and 332, and equipment state information of micro-grids 31 to 33. The control determination unit 3220 transmits the calculated operation plan to the control command unit 3219 and the transmitting/receiving unit 3218.

The control command unit 3219 controls the distributed power supply 322 and the switch 324 according to the acquired operation plan.

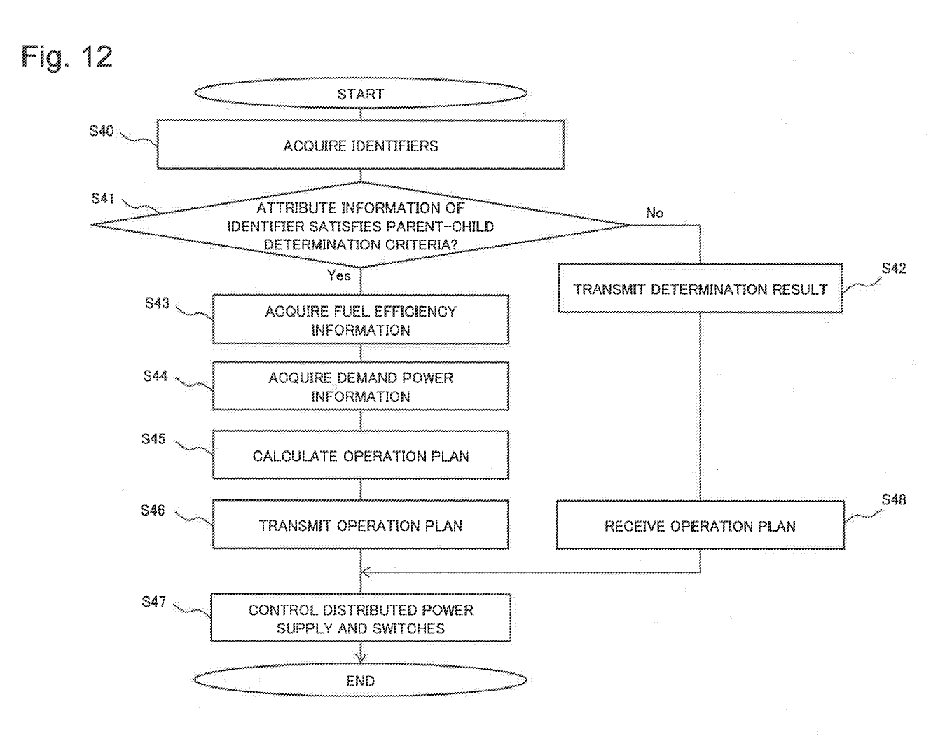

FIG. 12 illustrates a flowchart of an operation of the station control device 321 in the present example embodiment.

In S40, the transmitting/receiving unit 3218 acquires identifiers of the other station control devices 311, and 331, and the target station control device 321. An identifier includes information indicating a micro-grid to which a station control device as a transmission source belongs. Further, an identifier may further include information indicating a processing ability of a station control device as a transmission source. The transmitting/receiving unit 3218 transmits the acquired identifiers to the state monitoring unit 3221.

In S41, the state monitoring unit 3221 receives identifiers from the transmitting/receiving unit 3218, and determines a parent station control device with use of the received identifiers. The state monitoring unit 3221 determines one parent station control device, and at least one child station control device on the basis of predetermined parent-child determination criteria and identifiers.

Parent-child determination criteria are not specifically limited.

For instance, parent-child determination criteria may be criteria such that a station control device in a good communication environment is made to be a parent station control device. When the acquired identifier includes information indicating a processing ability of a station control device, the processing ability of the station control device may be used as parent-child determination criteria.

The state monitoring unit 3221 transmits a parent-child determination result to the control determination unit 3220 and the transmitting/receiving unit 3218.

When a station control device other than the station control device 321 is determined as a parent station control device, in S42, the transmitting/receiving unit 3218 transmits the parent-child determination result to the parent station control device. The transmitting/receiving unit 3218 may further transmit the parent-child determination result to a station control device other than a parent station control device.

When the station control device 321 is determined as a parent station control device, in S43, the transmitting/receiving unit 3218 communicates with the distributed power supply 322, and acquires fuel efficiency information of the distributed power supply 322. Further, the transmitting/receiving unit 3218 communicates with the station control devices 311 and 331 included in the other micro-grids 31 and 33, and acquires fuel efficiency information of the distributed power supplies 312 and 332.

In S44, the transmitting/receiving unit 3218 acquires demand power information indicating demand power of the loads 313, 323, and 333.

In S45, the control determination unit 3220 calculates (computes) an operation plan in such a way as to further reduce an energy cost with use of the acquired fuel efficiency information of the distributed power supplies 312, 322, and 332, and the acquired demand power information of the loads 313, 323, and 333. The control determination unit 3220 transmits the calculated operation plan to the control command unit 3219 and the transmitting/receiving unit 3218.

In S46, the transmitting receiving unit 3218 transmits an operation plan acquired from the control determination unit 3220 to the station control devices 311 and 331 that are child station control devices.

In S47, the control command unit 3219 controls the distributed power supply 322 and the switches 324 and 325 on the basis of the acquired operation plan.

As described above, in the present example embodiment, a parent station control device is determined on the basis of identifiers and parent-child determination criteria. According to the present example embodiment as described above, it is possible to reduce occurrence of inconveniences that an operation plan is incomplete or a control command cannot be transmitted to the other station control device, because a station control device suitable for calculation of an operation plan can be selected.

### Fifth Example Embodiment

An equipment state or demand power may change during a period of time from generating or transmitting/receiving an operation plan until the operation plan is started, or during a period of time when an operation plan is executed. In this case, it may not be possible to compensate demand power of micro-grids 31, 32, and 33 by a distributed power supply in operation, and a power cut may occur. In view of the above, in the present example embodiment, an operation plan is re-calculated according to a state of a micro-grid.

A transmitting/receiving unit 3118 of a station control device 311 acquires power measurement information of the micro-grid 31. Power measurement information in the present example embodiment includes electric power supplied to a load 313, and electric power consumed by the micro-grid 31. Electric power supplied to the load 313 includes electric power generated by a distributed power supply 312, and electric power supplied from the other micro-grids 32 and 33 via a power line 40. Electric power consumed by the micro-grid 31 includes electric power consumed by the load 313, and electric power supplied to the other micro-grids 32 and 33 by the micro-grid 31.

A state monitoring unit 3121 judges whether or not it is necessary to re-calculate an operation plan. For instance, the state monitoring unit 3121 may compare electric power supplied to the load 313, and the sum of electric power consumed by the load 313 and electric power supplied to the other micro-grids 32 and 33 by the micro-grid 31 with use of power measurement information. Further, the state monitoring unit 3121 may judge that it is necessary to re-calculate an operation plan when a difference between the two values as a comparison result is equal to or smaller than a certain value. Alternatively, the state monitoring unit 3121 may judge that re-calculation is necessary when a difference between the sum of electric power consumed by the load 313 and electric power supplied to the other micro-grids 32 and 33 by the micro-grid 31, and rated power of a distributed power supply represented by fuel efficiency information is equal to or smaller than a certain value. As another example, the state monitoring unit 3121 may judge that re-calculation of an operation plan is necessary when electric power consumed by the load 313 and electric power supplied to the other micro-grids 32 and 33 by the micro-grid 31 are equal to or smaller than a threshold value, in other words, when a load factor is equal to or smaller than a certain value.

When the station control device 311 is a parent station control device, a control determination unit 3120 of the station control device 311 re-calculates an operation plan.

When the station control device 311 is a child station control device, the transmitting/receiving unit 3118 may transmit a re-calculation command to a parent station control device. Alternatively, information indicating that the station control device 311 re-calculates an operation plan may be transmitted to the parent station control device. A parent station control device which acquires the information, may transmit fuel efficiency information or demand power information used for re-calculation, or an identifier of a micro-grid which belongs to a calculation group, to a station control device which performs re-calculation. An operation, until calculation of an operation plan is started, is able to be omitted by acquiring information used in calculation of an operation plan by a parent station control. Further, it is possible to calculate an operation plan under the same condition as a parent station control device. This is advantageous in reducing an influence by a difference in station control devices. For instance, it is possible to reduce inconveniences such as confusion of control due to acquisition of a plurality of operation plans, or occurrence of a micro-grid to which electric power is not supplied, since a calculation group is changed due to a communicable other station control device being different.

### Sixth Example Embodiment

The processing ability of a station control device may not be sufficient when obtaining an operation plan for a long period of time (for one month, for sixth months, or the like), or when calculating an operation plan of higher accuracy. In view of the above, a distributed power supply system in the present example embodiment includes a central control device having a higher processing ability than a station control device.

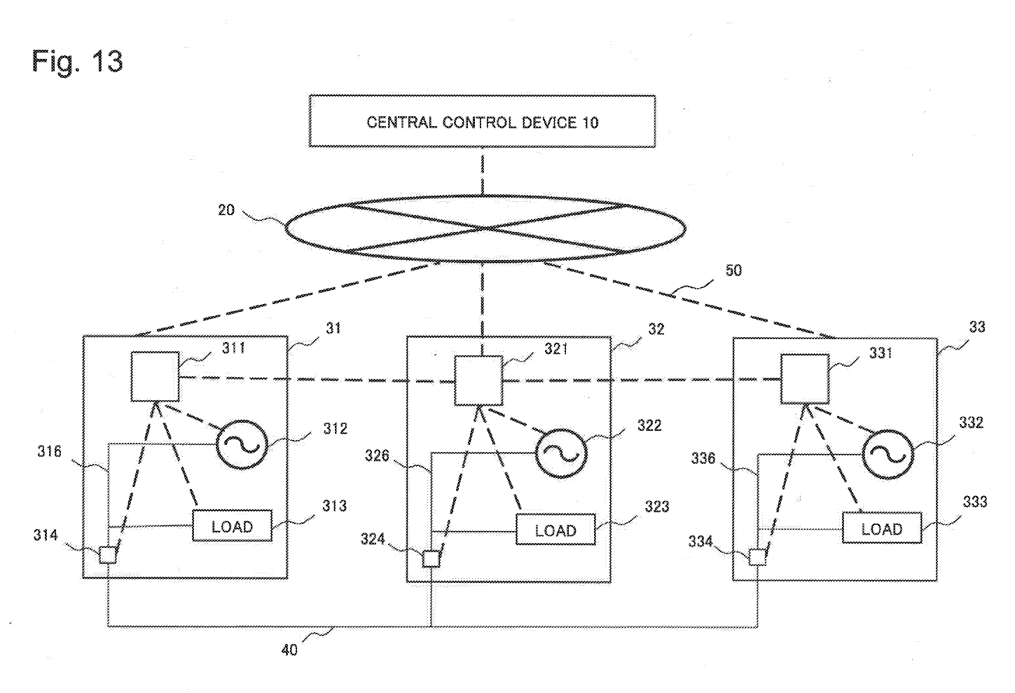

FIG. 13 illustrates an example of the distributed power supply system in the present example embodiment. The distributed power supply system in the present example embodiment includes a central control device 10, micro-grids 31 to 33, a power line 40, a communication network 20, and a communication line 50. The central control device 10, and each of station control devices 311, 321, and 331 are connected via the communication network 20.

The central control device 10 estimates demand power on the basis of information acquired from the station control devices 311, 321, and 331. Further, the central control device 10 is allowed to calculate an operation plan on the basis of information acquired from the station control devices 311, 321, and 331.

The central control device 10 acquires measurement of electric power to be consumed by each of loads 313, 323, and 333, and estimates demand power of the loads 313, 323, and 333 for a certain period of time on the basis of the acquired information. Further, the central control device 10 may acquire output-fuel consumption characteristics information of distributed power supplies 312, 322, and 332, and may calculate an operation plan of the micro-grids 31, 32, and 33 for a certain period of time (for a week, for a month, or the like) with use of an estimation result of demand power and output-fuel consumption characteristics information. The central control device 10 transmits the calculated estimation result or operation plan to a parent station control device. Note that the central control device 10 may estimate demand power of the plurality of the micro-grids 31 to 33 and calculate an operation plan, or may calculate only with respect to a micro-grid for which calculation accuracy of a certain level or higher is necessary.

A parent station control device is allowed to calculate an operation plan with use of demand power information acquired from the central control device 10. A parent station control device may use an estimation result acquired from a central control device as demand power information for calculation of an operation plan. By using an estimation result estimated by a central control device having a high processing ability, an operation plan is calculated with use of an estimation result of higher accuracy, as compared with a configuration in which estimation is performed by a station control device.

Further, a parent station control device is allowed to re-calculate demand power information or an operation plan by using an estimation result of demand power or an operation plan, which is acquired from the central control device 10. For instance, a parent station control device may calculate demand power for a shorter period of time (every hour, every day, or the like) with use of an estimation result or an operation plan for a certain period of time, which is acquired from a central control device. By calculating demand power information with use of an estimation result calculated by a central control device and with use of a measurement value acquired from a load, the amount of calculation is able to be reduced while reflecting power information at a point of time of measurement.

According to the present example embodiment, an operation plan is calculated by using an estimation result of demand power, which is calculated by a central control device with a higher processing ability than a station control device. According to the present example embodiment, it is possible to calculate an operation plan with higher accuracy, and to calculate an operation plan for a longer period of time. Further, it is not necessary for a station control device to estimate demand power. This is advantageous in reducing the amount of calculation by a parent station control device.

### Other Example Embodiments

In the foregoing, the example embodiments of the present invention are described referring to the drawings. However, these are merely examples of the present invention. Various configurations other than the aforementioned combinations and the aforementioned configurations may be adopted. For instance, demand power at which the efficiency of a distributed power supply is maximized in the aforementioned example embodiments may be notified to the owner or the manager of a load of each of the micro-grids. Alternatively, with use of demand power information and fuel efficiency information in the aforementioned example embodiments, it is possible to make proposals of a maintenance period of a distributed power supply, or a distributed power supply for which maintenance is performed, which makes the efficiency of a distributed power supply equal to or higher than a certain efficiency.

Further, the directions of arrows indicated in FIG. 3, FIG. 4, FIG. 6, FIG. 7, and FIG. 10 are merely an example, and the directions of signals between the blocks are not limited.

In the aforementioned examples, a program is stored with use of a non-transitory computer readable medium of various types, and is suppliable to a computer. A non-transitory computer readable medium includes a tangible storage medium of various types. Examples of a non-transitory computer readable medium include a magnetic recording medium (a flexible disk, a magnetic tape, or a hard disk drive, for example), a magneto-optical recording medium (a magneto-optical disk, for example), a CD-ROM (read only memory), a CD-R, a CD-R/W, a DVD (digital versatile disc), a BD (Blu-ray (registered trademark) disc), a semiconductor memory (a mask ROM, a PROM (programmable ROM), an EPROM (erasable PROM), a flash ROM, and an RAM (random access memory), for example). Further, a program may be supplied to a computer by a transitory computer readable medium of various types. Examples of a transitory computer readable medium include an electrical signal, an optical signal, and an electromagnetic wave. A transitory computer readable medium is capable of supplying a program to a computer via a wired communication path such as an electric cable and an optical fiber, or a wireless communication path.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2014-158810, filed on Aug. 4, 2014, the disclosure of which is incorporated herein in its entirety by reference.

### REFERENCE SIGNS LIST

10 Central control device

20 Network

40 Power line

50 Communication line

31, 32, 33 Micro-grid

311, 321, 331 Station control device

312, 322, 332 Distributed power supply

313, 323, 333 Load

314, 324, 334, 315, 325, 335 Switch

316, 326, 336 Power line

3218 Transmitting/receiving unit

3219 Control command unit

3220 Control determination unit

3221 State monitoring unit

3222 Calculation group determination unit

1. A station control device which:
controls start and stop of a distributed power supply which supplies electric power to a load consuming electric power, and connection and disconnection of a switch which connects the distributed power supply and the load with another distributed power supply controlled by another station control device; and
controls the switch and the distributed power supply, based on demand power information indicating electric power consumed by the load, fuel efficiency information indicating an output-fuel consumption characteristic of the distributed power supply, the demand power information of another load to which electric power is supplied by the another distributed power supply, and the fuel efficiency information of the another distributed power supply.

2. A station control device which:
controls start and stop of a distributed power supply which supplies electric power to a load consuming electric power, and connection and disconnection of a switch which connects a distributed power supply and the load with another distributed power supply controlled by another station control device; and
instructs another station control device to control the another distributed power supply, based on
demand power information indicating electric power consumed by the load, fuel efficiency information indicating an output-fuel consumption characteristic of the distributed power supply, the demand power information of another load to which electric power is supplied by the another distributed power supply, and the fuel efficiency information of the another distributed power supply.

3. The station control device according to claim 2, which
instructs another station control device to control another switch controlled by the another station control device.

4. The station control device according to claim 1 or 2, which
calculates an operation plan indicating combination of controlling contents with respect to the distributed power supply, the another distributed power supply, the switch, and the another switch, based on
demand power information indicating electric power consumed by the load, fuel efficiency information indicating an output-fuel consumption characteristic of the distributed power supply, the demand power information of another load to which electric power is supplied by the another distributed power supply, and the fuel efficiency information of the another distributed power supply.

5. The station control device according to claim 1, wherein
the control further includes changing a number of rotations or a rotational speed of a distributed power supply.

6. The station control device according to claim 4, which
calculates the operation plan in such a manner that a sum of energy costs of the distributed power supply and the another distributed power supply is reduced.

7. The station control device according to claim 4, which
further acquires equipment state information indicating information indicating an operation state of the distributed power supply and the switch, and equipment state information of the another distributed power supply and another switch, and
calculates an operation plan in such a way as to continue the operation state.

8. The station control device according to claim 7, wherein
the equipment state information includes information indicating whether or not the distributed power supply and the switch are usable, and
the station control device calculates an operation plan, based on whether or not the distributed power supply and the switch are usable.

9. The station control device according to claim 4, which
acquires an identifier identifying the another station control device as a transmission source,
judges whether or not being communicable with the another station control device, based on the acquired identifier, and
calculates an operation plan of the distributed power supply and the switch, controlled by the another communicable station control device when an identifier of the another station control device which is judged to be communicable satisfies a predetermined condition.

10. The station control device according to claim 9, which
calculates an operation plan of the distributed power supply and the switch, controlled by the another communicable station control device when a sum of the another communicable station control devices is equal to or larger than a fixed number.

11. The station control device according to claim 4, wherein
the identifier includes information indicating a processing ability of the station control device, and
the station control device determines a station control device which calculates the operation plan out of a plurality of the station control devices, based on a degree of the processing ability.

12. (canceled)

13. (canceled)

14. (canceled)

15. (canceled)

16. A control method for controlling start and stop of a distributed power supply which supplies electric power to a load consuming electric power, and connection and disconnection of a switch which connects a distributed power supply and the load with another distributed power supply controlled by another station control device, the method comprising
controlling the switch and the distributed power supply by using
demand power information indicating electric power consumed by the load,
fuel efficiency information indicating an output-fuel consumption characteristic of the distributed power supply,
demand power information of another load to which electric power is supplied from the another distributed power supply, and
fuel efficiency information of the another distributed power supply.
